(19) United States
(12) Patent Application Publication
(10) Pub. No.: US 2016/0223183 A1
(43) Pub. Date: Aug. 4, 2016

(54) LED LAMP

(71) Applicants: XIAOFENG ZOU, SHENZHEN (CN); QIANG LI, SHENZHEN (CN); YEREN LIU, SHENZHEN (CN); ZHIJIN LIN, SHENZHEN (CN); KAIFA MO, SHENZHEN (CN); RENGUI ZHOU, SHENZHEN (CN)

(72) Inventors: XIAOFENG ZOU, SHENZHEN (CN); QIANG LI, SHENZHEN (CN); YEREN LIU, SHENZHEN (CN); ZHIJIN LIN, SHENZHEN (CN); KAIFA MO, SHENZHEN (CN); RENGUI ZHOU, SHENZHEN (CN)

(21) Appl. No.: 15/009,443

(22) Filed: Jan. 28, 2016

(30) Foreign Application Priority Data
Feb. 3, 2015 (CN) 201520081094.X
Nov. 4, 2015 (CN) 201520872722.6

(51) Int. Cl. F21V 29/74; F21V 29/80; F21V 29/60

(52) U.S. Cl. CPC F21V 29/74; F21V 29/60; F21V 29/80; F21Y 2101/02

(57) ABSTRACT

A LED lamp comprises a housing and a heat sink module provided on the housing and comprising a base plate, wherein one side of the base plate is provided with a heat-dissipating plane and the other side thereof is provided with a plurality of heat-dissipating structures, an air passage is formed among the heat-dissipating structures; the heat sink module further comprises at least a power device, an air outlet of the power device is aligned with the air passage. A LED lamp comprises a bracket and a lamp provided on the bracket; the bracket comprises a first bracket and a second bracket; the second bracket comprises a connecting portion and a connecting arm extending from both ends of the connecting portion to a same side thereof; the lamp is mounted on the connecting arm, a screw is provided on the first bracket, a fixed hole is provided on the connecting portion of the second bracket, the screw extends through the fixed hole of the second bracket and is locked by a nut.

### FIELD OF THE INVENTION

The present disclosure relates to a lighting field, and more particularly relates to a LED lamp.

### BACKGROUND OF THE INVENTION

As the technical development, the LED lamp is increasingly popular due to its advantages of high luminous efficiency, less power consumption, long life and the like. However, the issues related to heat dissipation are important factors for limiting its development. In prior art, the air passage are provided to dissipate heat generated by the power supply, circuit board and other heating elements, or heat exchange with the external is implemented by the lamp body. However, both such manners have disadvantages of a lower efficiency of heat dissipation, difficulty providing specific heat dissipation for the heating source. In other words, the solutions in prior art cannot solve these disadvantages.

Currently, in the lighting industrial, the lamp is always provided with a lamp holder and a base for enabling the lamp to fix in the lamp shade. For example, the E40 lamp holder is mounted onto the E40 base. When the above is used, there are a number of issues: 1. the base may shake, and the lamp may not be mounted stably; 2. when the power supply is turned on, the base is charged, resulting in safety problems for operators; 3. When the lamp holder and the lamp cradle is assembled, the lamp holder is twisted and then connected to the lamp cradle. However, when the lamp holder is twisted to the end, the radiating angle of the lamp is generally not best, and then it needs to be adjusted, resulting in inconvenient mounting of the lamp.

### SUMMARY OF THE INVENTION

On the basis of this, it is necessary to provide a LED lamp.

An LED lamp includes a housing and a heat sink module received on the housing and comprising: a base plate having a heat-dissipating plane; a plurality of heat-dissipating structures arranged on another side of the base plate away from the heat-dissipating plane, wherein an air passage is formed among the heat-dissipating structures; and at least one power device having an air outlet aligned with the air passage.

In one embodiment, the power device is an air pump and/or an electric fan.

In one embodiment, the heat-dissipating structures are cooling fins and/or cooling pins which are arranged in parallel with each other.

In one embodiment, the heat-dissipating structures are cooling fins and/or cooling pins which are arranged in a ring.

In one embodiment, the heat-dissipating structures are cooling fins provided with a plurality of ripple structures thereon.

In one embodiment, a groove is provided on the heat-dissipating structures.

In one embodiment, the base plate is provided with an extending portion configured to mount the power device.

Wherein the power device is surrounded by the heat-dissipating structures.

Wherein the heat sink module includes two horizontally arranged power devices, the two power devices are located at a same side of the heat-dissipating structures in parallel, or at both sides of the heat-dissipating structures symmetrically.

The power device is arranged in a vertical or horizontal direction.

In one embodiment, the LED lamp further includes a connecting component configured to fasten the housing and the heat sink module.

In an embodiment, the connecting component includes: a mounting plate fastened to the base plate; and a plurality of first brackets provided along a periphery of the mounting plate, wherein each bracket defines a plurality of depressions which are evenly distributed and perpendicular to a length direction thereof.

In one embodiment, the connecting component includes a mounting plate fastened to the base plate; a plurality of second brackets provided along a periphery of the mounting plate; a plurality of third brackets being able to slide along a length of the second brackets; and a fastener; wherein each second and third brackets define a groove and the fastener extends through the groove.

In one embodiment, the connecting component includes a fourth bracket fastened to the base plate; a fifth bracket mounted on the fourth bracket; and a cradle and a clamp provided on the fifth bracket; wherein a relative position between the fourth bracket and the fifth bracket is adjustable; the fourth bracket defines a hole; the fifth bracket defines a plurality of holes and/or grooves along a length of the fifth bracket.

In one embodiment, the connecting component includes a mounting base having a L shape and adjustably mounted on the base plate by its vertical side wall; and a sixth bracket; wherein the sixth bracket defines a plurality of notches provided at both sides of the sixth bracket symmetrically, a plurality of depressions perpendicular to a length of the sixth bracket and connected to the lowest position of the notches at both sides, a groove provided along the length of the sixth bracket, and a long circular hole; a vertical side wall of the mounting base can be adjusted; when the sixth bracket is bolted on a horizontal side wall of the mounting base by the long circular hole, an angle and an extending portion length of the sixth bracket is adjustable.

An LED lamp includes a bracket including: a first bracket provided with a screw; and a second bracket comprising a connecting portion and two connecting arms extending from both ends of the connecting portion along a same side thereof; wherein the second bracket defines a fixing hole on the connecting portion, the screw extends through the fixing hole and is locked by a nut, thereby fastening the second bracket to the first bracket; and a lamp mounted on the connecting arms.

In one embodiment, the first bracket is an L-shaped bracket having a base plate and a vertical plate extending from the base plate; the base plate defines an elongated hole, and the screw is located on the vertical plate.

In one embodiment, the L-shaped bracket is formed by bending a metal plate.

In one embodiment, a screw hole is provided on the vertical plate of the L-shaped bracket, the screw extends through the screw hole and is pre-mounted on the L-shaped bracket by a preload nut.

In one embodiment, the second bracket is a U-shaped bracket formed by bending a metal plate, and a plurality of connecting holes for mounting the lamp are provided on an end of the U-shaped bracket.

In one embodiment, the lamp includes a heat sink module and a light emitting diode module, wherein a plurality of heat-dissipating structures are provided on the heat sink module, an air passage for passing an airflow through is formed among the heat-dissipating structures, connecting sheets are provided at both sides of the heat sink module, and the light emitting diode module is mounted on the connecting arm of the second bracket by the connecting sheets.

In one embodiment, the heat-dissipating structures include a plurality of cooling fins and/or cooling pins extending from a base plate of the heat sink module.

In one embodiment, a blower is provided on the heat sink module, and an outlet of the blower is aligned with the air passage.

In one embodiment, the blower is an air pump and/or an electric fan.

The solution of the present invention can specifically dissipate heat generated by the heating elements in the LED lamp, and has advantages of high efficiency of heat dissipation, long life for use, low noise, dust resistance and the like. The LED lamp can resist lashing and vibrating, has a simple structure, and can be maintained easily. Moreover, when the LED lamp of the present invention is used, the pre-mounted nut on the screw is slacked and unloaded. Then, the screw extends through the fixed hole of the second bracket on which the lamp is mounted and fixed, and the nut is mounted on the screw. Further, the screw is regarded as an axis and the emitting light direction of the lamp on the second bracket is adjusted according to the axis, and the second bracket is locked on the first bracket by tightening the nut. The LED lamp can be mounted stably without risk of an electric shock while well controlling the angle of radiating light.

### BRIEF DESCRIPTION OF THE DRAWINGS

These and other features of the present invention will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is a perspective view of a LED lamp in accordance with a first embodiment;

FIG. 2 is a side view of the LED lamp in FIG. 1;

FIG. 3 is a partial, enlarged view of part A in FIG. 2;

FIG. 4 is a perspective view of a LED lamp in accordance with a second embodiment;

FIG. 5 is a perspective view of a LED lamp in accordance with a third embodiment;

FIG. 6 is a perspective view of a LED lamp in accordance with a fourth embodiment;

FIG. 7 is a perspective view of a LED lamp in accordance with a fifth embodiment;

FIG. 8 is a perspective view of a LED lamp in accordance with a sixth embodiment;

FIG. 9 is a perspective view of a LED lamp in accordance with a seventh embodiment;

FIG. 10 is a perspective view of a LED lamp in accordance with an eighth embodiment;

FIG. 11 is a perspective view of a LED lamp in accordance with a ninth embodiment;

FIG. 12 is a perspective view of a LED lamp in accordance with a tenth embodiment;

FIG. 13 is a perspective view of a LED lamp in accordance with an eleventh embodiment;

FIG. 14 is a perspective view of a combination of a first connecting component with a heat sink module in accordance with an embodiment;

FIG. 15 is a perspective view of a combination of the first connecting component with the heat sink module in accordance with another embodiment;

FIG. 16 is a perspective view of a combination of the first connecting component with the heat sink module in accordance with yet another embodiment;

FIG. 17 is a perspective view of a combination of a second connecting component with the heat sink module in accordance with an embodiment;

FIG. 18 is a perspective view of a combination of the second connecting component with the heat sink module in accordance with another embodiment;

FIG. 19 is a perspective view of a combination of the second connecting component with the heat sink module in accordance with yet another embodiment;

FIG. 20 is a perspective view of a combination of a third connecting component with the heat sink module in accordance with an embodiment;

FIG. 21 is a perspective view of a combination of the third connecting component with the heat sink module in accordance with another embodiment;

FIG. 22 is a perspective view of a combination of the third connecting component with the heat sink module in accordance with yet another embodiment;

FIG. 23 is a perspective view of a combination of a fourth connecting component with the heat sink module in accordance with an embodiment;

FIG. 24 is a perspective view of a combination of a fifth connecting component with the heat sink module in accordance with an embodiment;

FIG. 25 is a perspective view of using a fan as a power source in accordance with an embodiment;

FIG. 26 is a perspective view of a LED lamp in accordance with an embodiment.

### DETAILED DESCRIPTION OF THE EMBODIMENTS

For facilitating understanding of the present invention, the present invention will be described more fully hereinafter with reference to the related accompanying drawings. The better embodiments are given in the accompanying drawings. The invention may, however, be embodied in many different forms and should not be construed as limited to the embodiments set forth herein. Rather, the object for providing these embodiments is to understand this disclosure of the invention thoroughly and completely.

It needs to explain that when an element is referred to as being “fixed” to another element, it can be directly on the other element or intervening elements may be present. When an element is referred to as being “connected” to another element, it can be directly connected to the other element or intervening elements may be present at the same time.

Unless otherwise defined, all terms (including technical and scientific terms) used herein have the same meaning as commonly understood by one of ordinary skill in the art to which this invention belongs. Herein terms used in the specification of the invention aim at describing the specific embodiments without limiting the invention. Terms “and/or” used herein comprise any and all combination of one or more related item listed.

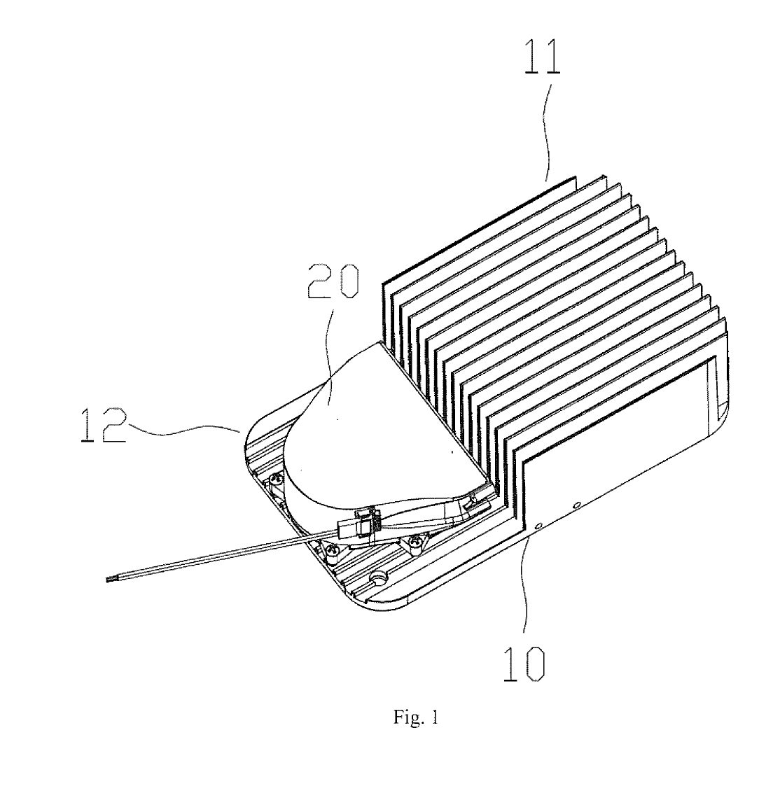

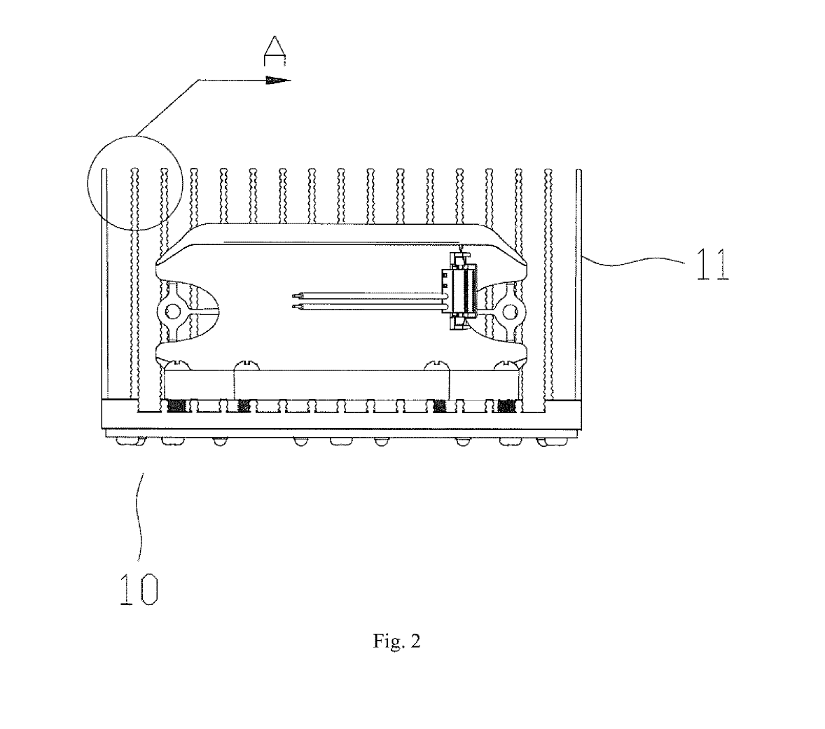

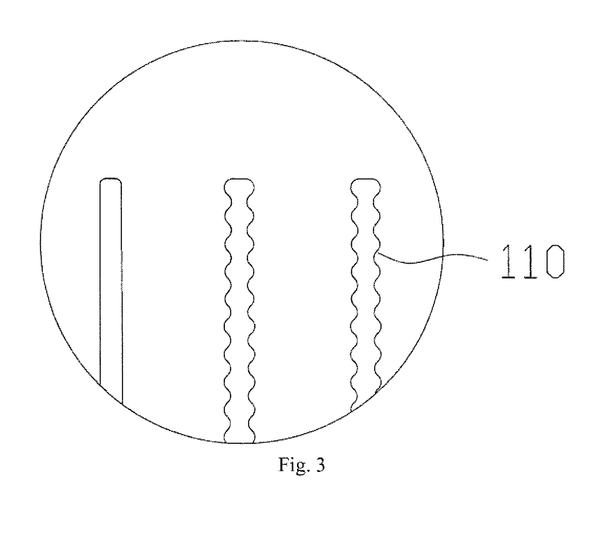

Referring to FIGS. 1 to 3, the LED lamp of the invention includes a housing (not shown) and a heat sink module received on the housing; the heat sink module includes a base plate 10, the bottom surface of the base plate 10 is a heat-dissipating plane, a heating source is detachably mounted on the heat-dissipating plane, for maximizing heat transmission therebetween.

A plurality of heat-dissipating structures are arranged on another side of the base plate 10 away from the heat-dissipating plane, and an air passage is formed among the heat-dissipating structures, for facilitating passing cold air through and then taking heat transmitted from the heat-dissipating plane away.

In one embodiment, the heat-dissipating structures may be cooling fins, cooling pins or combination thereof; the heat-dissipating structures may be arranged in a ring, in a rectangle, in parallel or at an angle with each other.

In one embodiment, the heat-dissipating structures are cooling fins 11 perpendicular to the base plate 10, which may significantly increase the heat-dissipating area. A plurality of air passages are formed by parallel arrangement of the cooling fins 11.

In one embodiment, a plurality of ripple structures 110 are evenly provided on the surface of the cooling fins 11 along the length of the cooling fins 11, which further increases the surface area of the cooling fins 11.

The heat sink module further includes at least one power device. In one embodiment, the power device may be an air pump 20, an air outlet of the power device is aligned with the air passages, for leading air through the heat-dissipating structures. The air pump 20 may be configured to separate from the heat-dissipating structures, covered by the heat-dissipating structures, arranged in a horizontal direction or in a vertical direction.

In one embodiment, an extending portion 12 is provided on the base plate 10, for fixing the air pump 20.

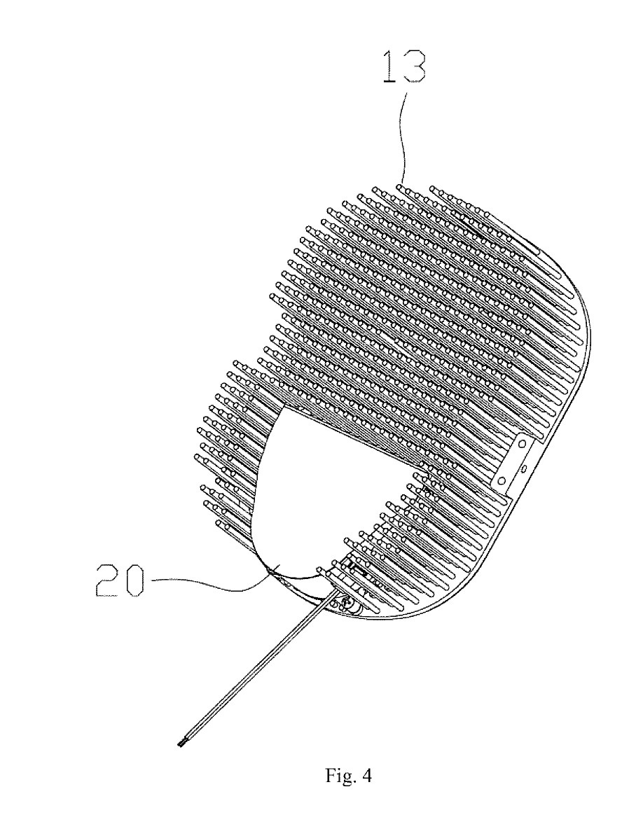

Referring to FIG. 4, the heat-dissipating structures include cooling pins 13 perpendicular to the base plate 10. With respect to the cooling fins, the cooling pins 13 have a larger heat-dissipating area on condition that their base plates have same area. Further, the arrangement of the cooling pins 13 enables the air passages to have more than one direction, for facilitating improving capacity of heat dissipation.

The cooling pins 13 extend toward both sides of the air pump 20, and cover the air pump 20, which can improve the heat-dissipating efficiency by fully using air flow escaping from the air outlet of the air pump 20.

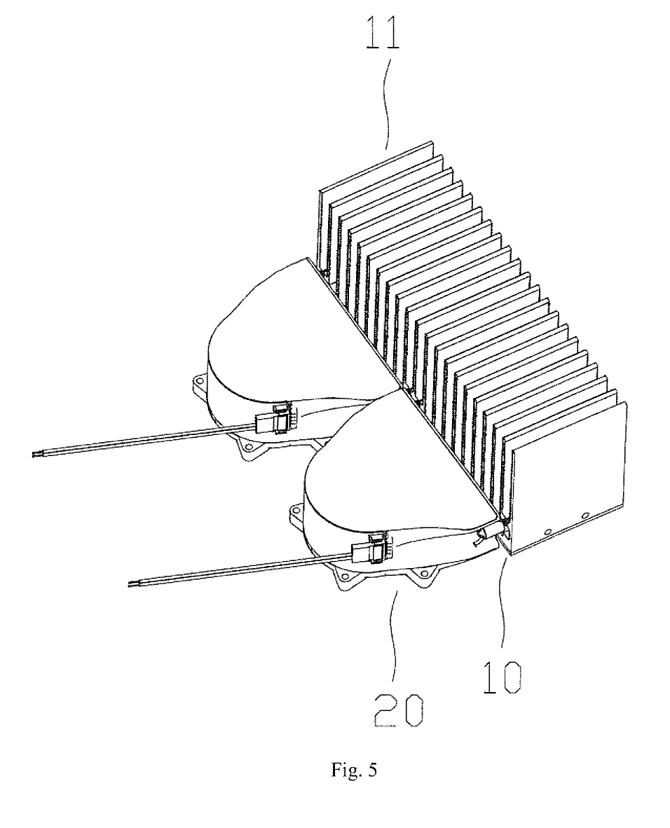

Referring to FIG. 5, there are two air pumps 20 which are arranged in parallel and directly fixed on the heat-dissipating structures, the mounting height of the two air pumps 20 can be freely adjusted, and the heat-dissipating structures are cooling fins 11 arranged in parallel.

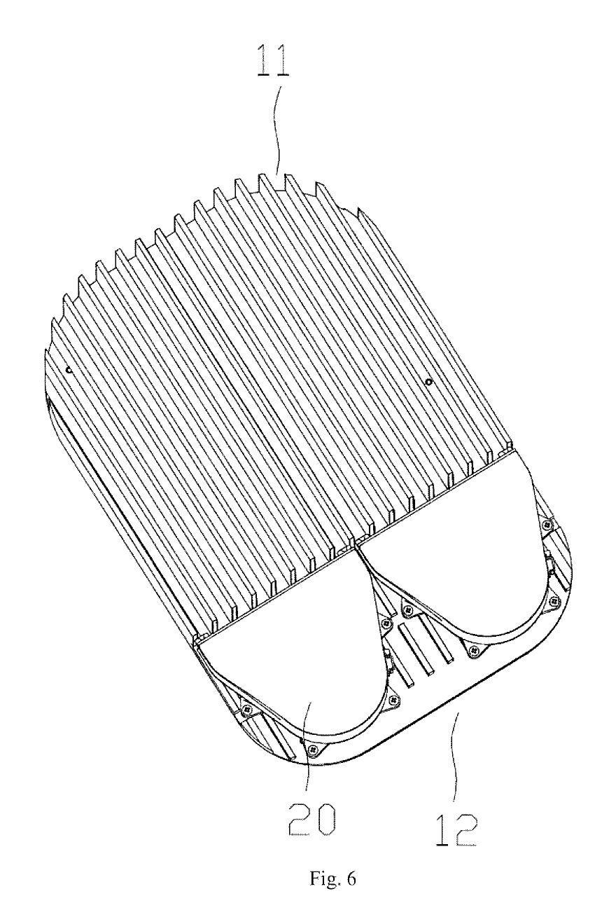

Referring to FIG. 6, there are two air pumps 20 which are arranged in parallel and fixed on the extending portion 12, and the heat-dissipating structures are cooling fins 11 arranged in parallel.

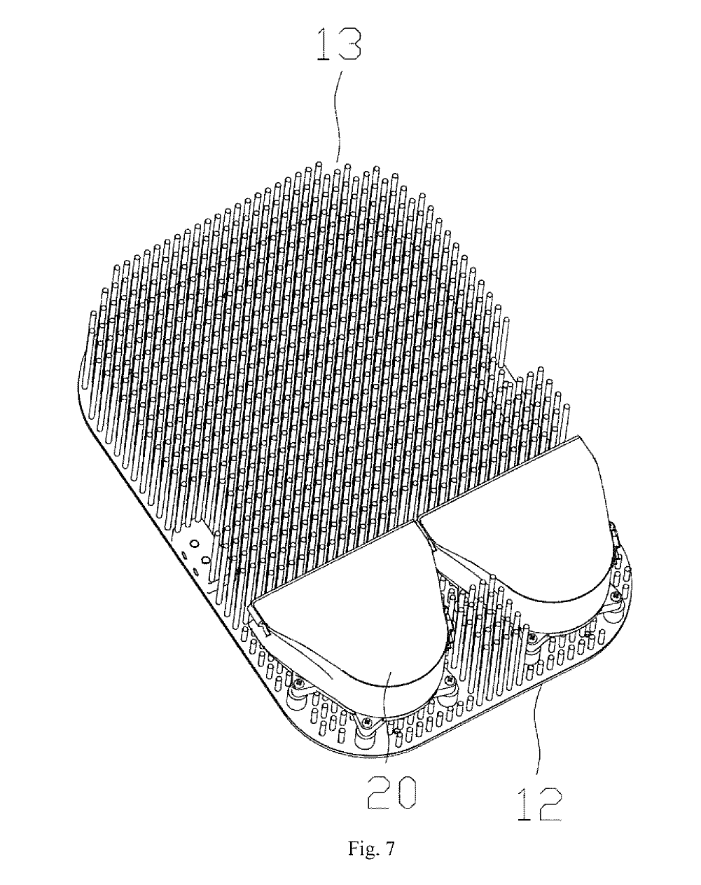

Referring to FIG. 7, there are two air pumps 20 which are arranged in parallel and fixed on the extending portion 12, and the heat-dissipating structures are cooling pins 13 arranged in parallel.

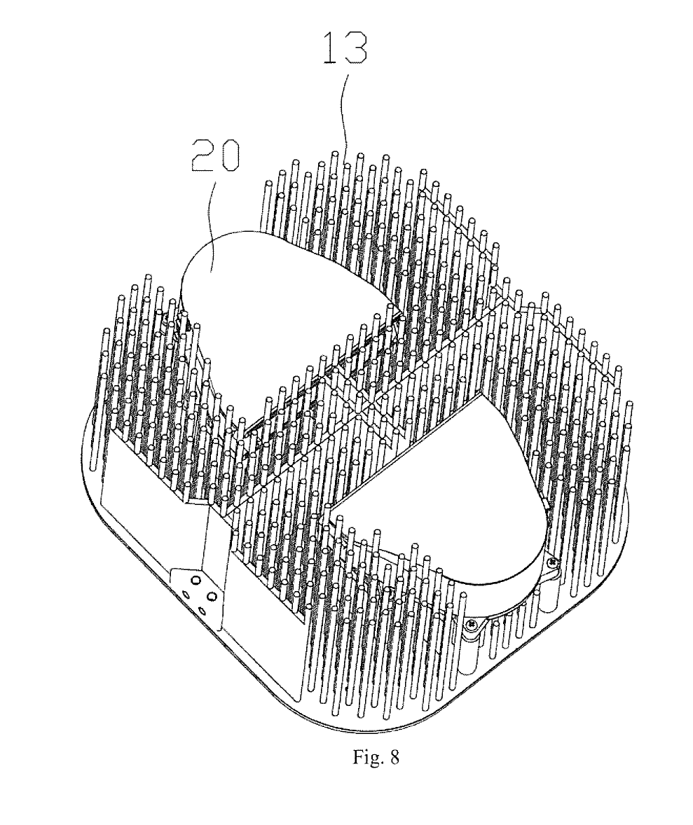

Referring to FIG. 8, there are two air pumps 20 which are placed symmetrically between which a separator is provided and covered by the heat-dissipating structures, and the heat-dissipating structures are cooling pins 13 arranged in parallel.

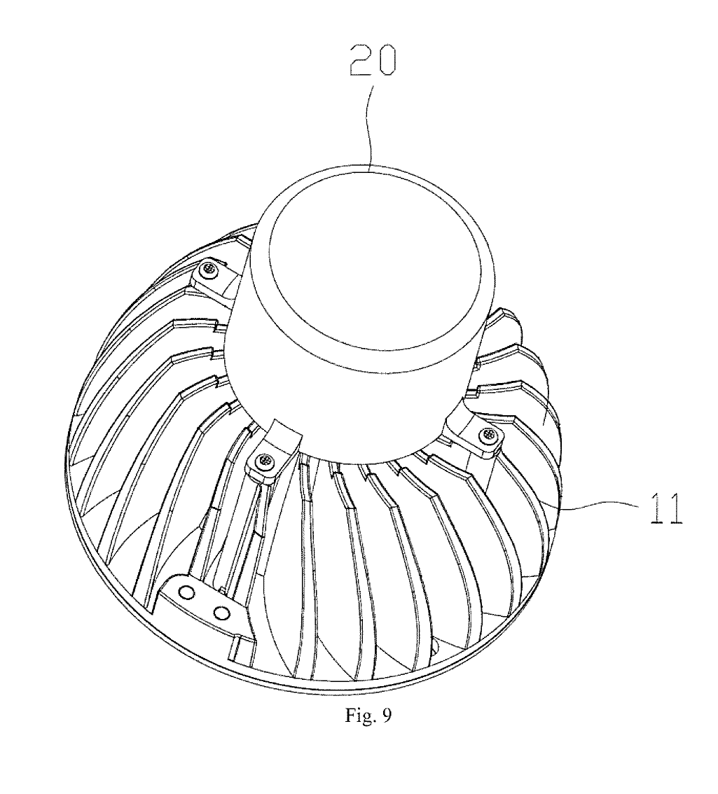

Referring to FIG. 9, there is one air pump 20 which is vertically provided on the heat-dissipating structures, and the heat-dissipating structures are cooling fins 11 arranged in a ring.

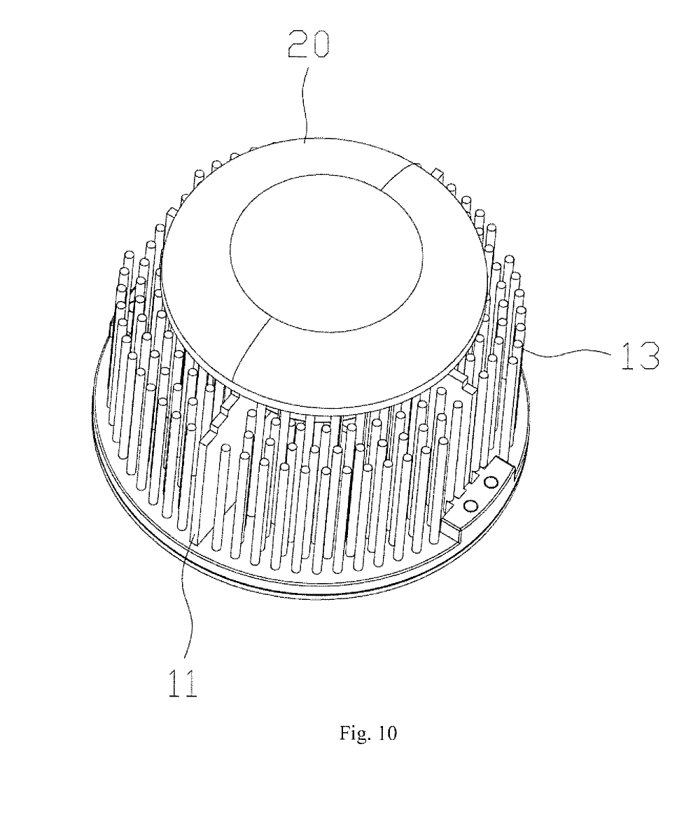

Referring to FIG. 10, there is one air pump 20 which is vertically provided on the heat-dissipating structures, and the heat-dissipating structures are combination of cooling fins 11 and cooling pins 13 arranged in a ring.

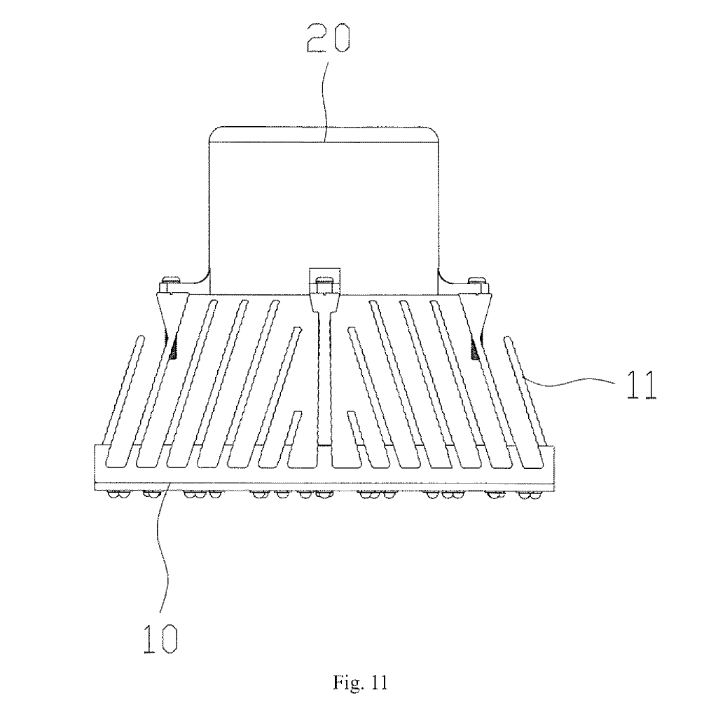

Referring to FIG. 11, there is one air pump 20 which is vertically provided on the heat-dissipating structures, and the heat-dissipating structures are cooling fins 11 which are divided into two parts by a separator, and the cooling fins 11 at a same side are arranged in parallel with each other and at an angle with respect to the base plate 10.

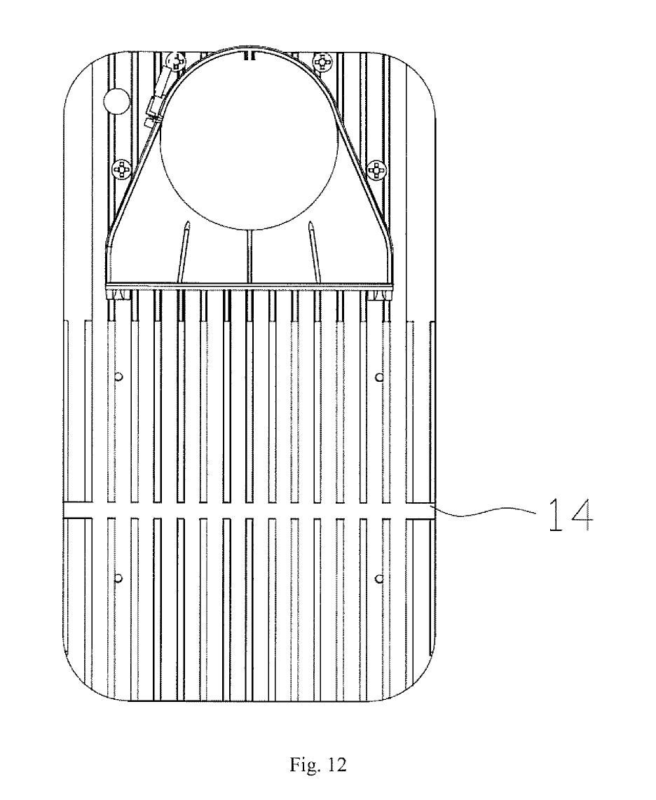

Referring to FIG. 12, a groove 14 is provided on the heat-dissipating structures and of a line shape.

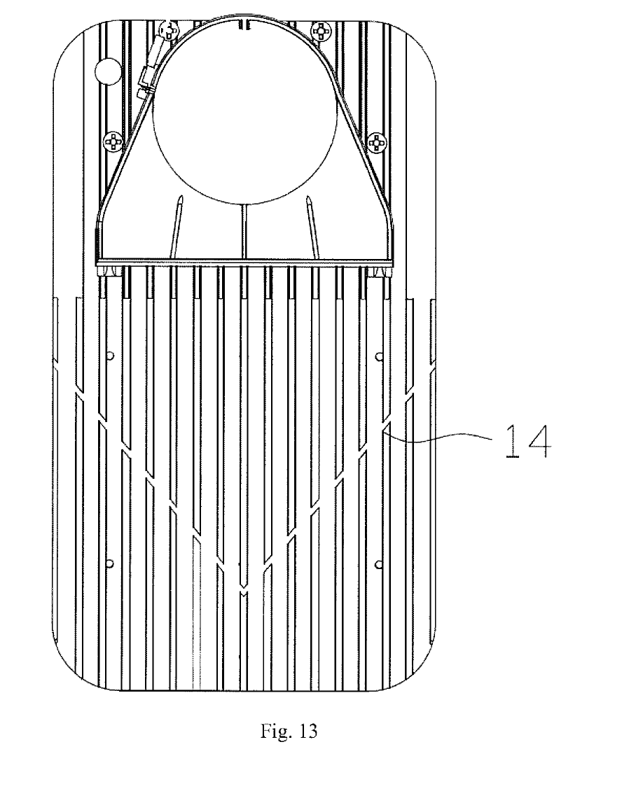

Referring to FIG. 13, a groove 14 is provided on the heat-dissipating structures and of a V shape.

The above solutions are only parts of embodiments of the invention, and do not limit shape and arrangement of the heat-dissipating structures, whether there is an extending portion, number and mounting direction of the air pump, and shape and number of the groove.

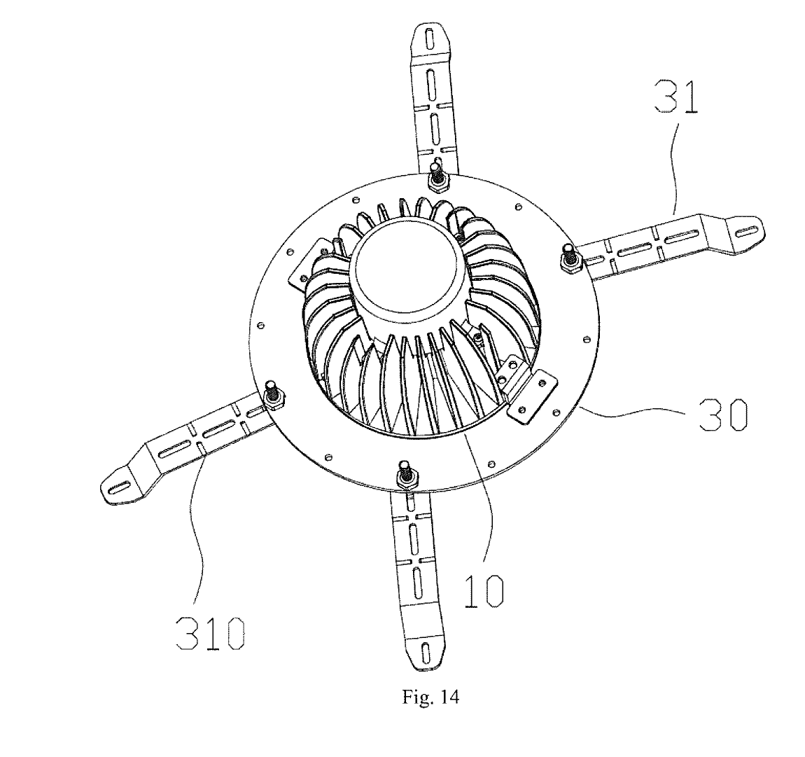

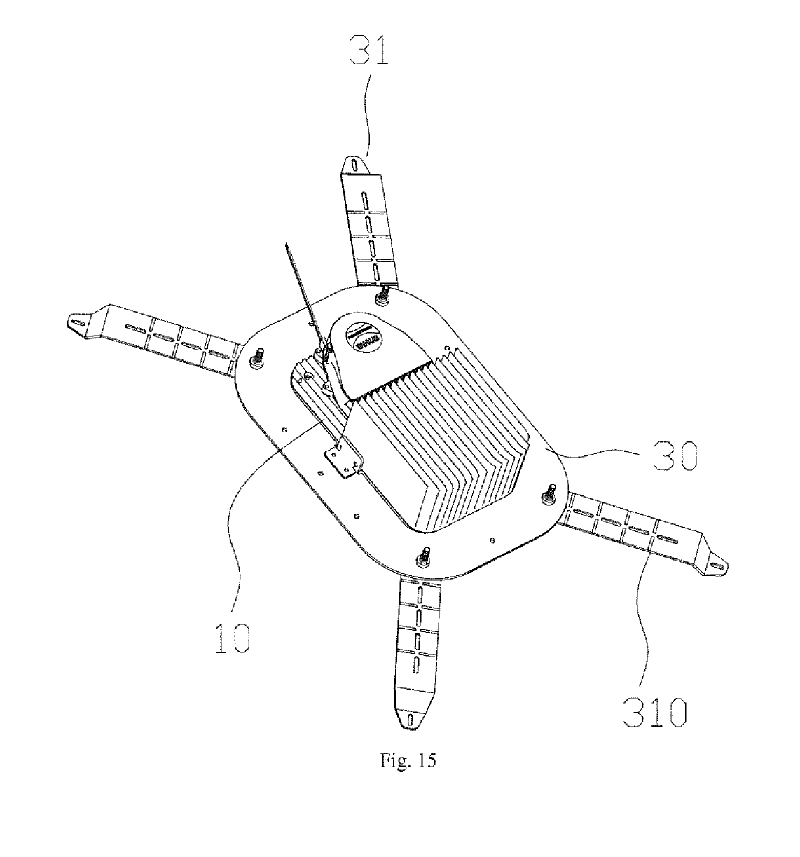

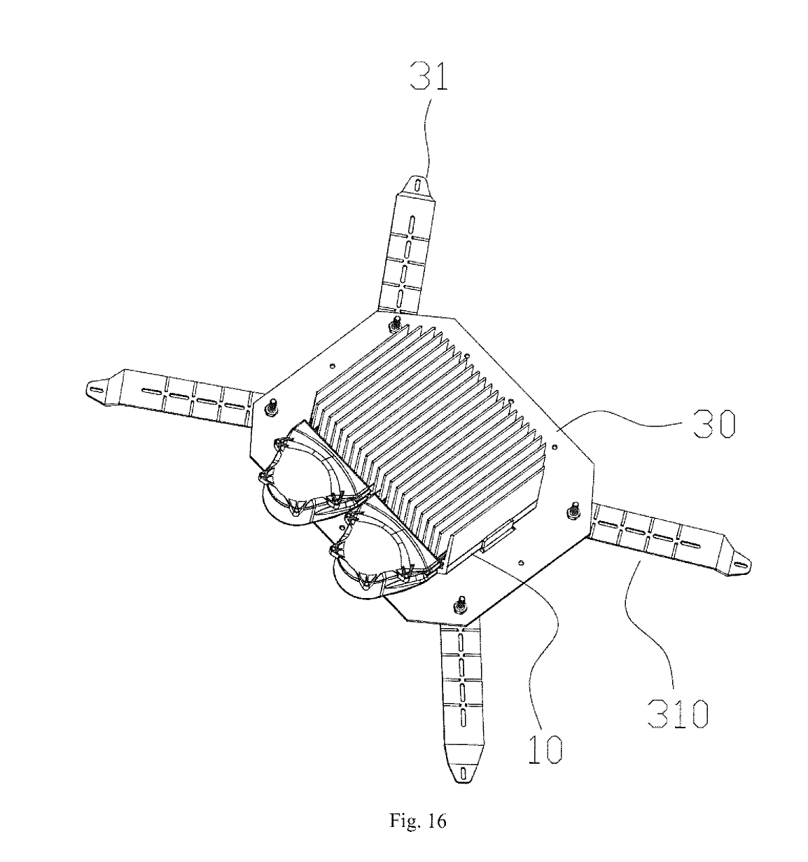

For facilitating mounting the heat sink module on the housing, a connecting component is also provided. Referring to FIGS. 14 to 16, in a first embodiment, the connecting component includes a mounting plate 30, the base plate 10 is fastened to the mounting plate 30, a plurality of first brackets 31 are evenly provided along the periphery of the mounting plate 30 and the length of the first brackets 31 can be adjusted.

The mounting plate 30 can be of a rectangle shape, a long circle shape and the like according to actual uses for adapting to the above different embodiments.

The first brackets 31 are of a thin sheet shape on which a plurality of depressions 310 perpendicular to the length of the first brackets 31 are evenly provided, and the depressions 310 can reduce strength which the bracket can bear. When it needs to adjust the length of the first brackets 31, an external force can be applied to the respective depressions, for breaking the first brackets 31 and enabling the first brackets 31 to match the housings of different sizes. Meanwhile, the first brackets 31 can be bent by the respective depressions to form a step structure of different shapes.

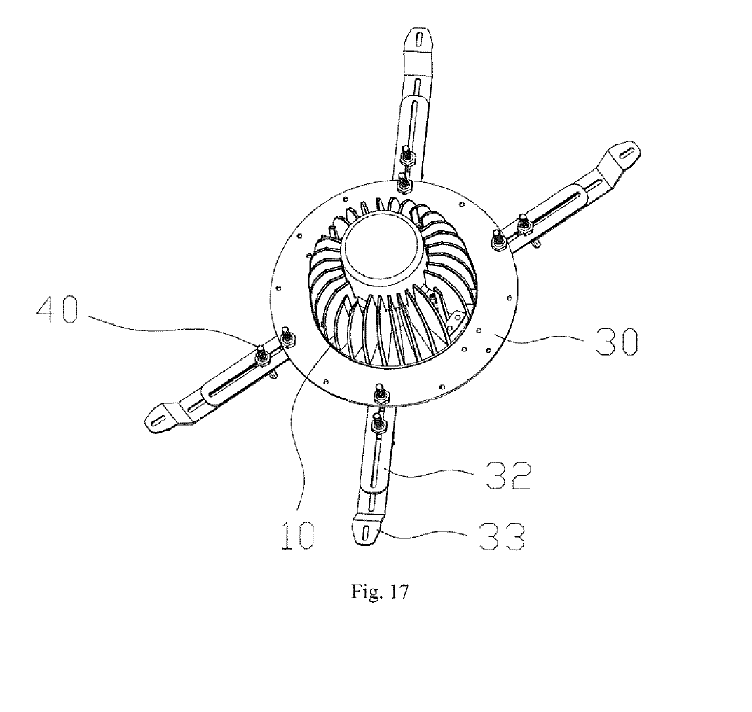

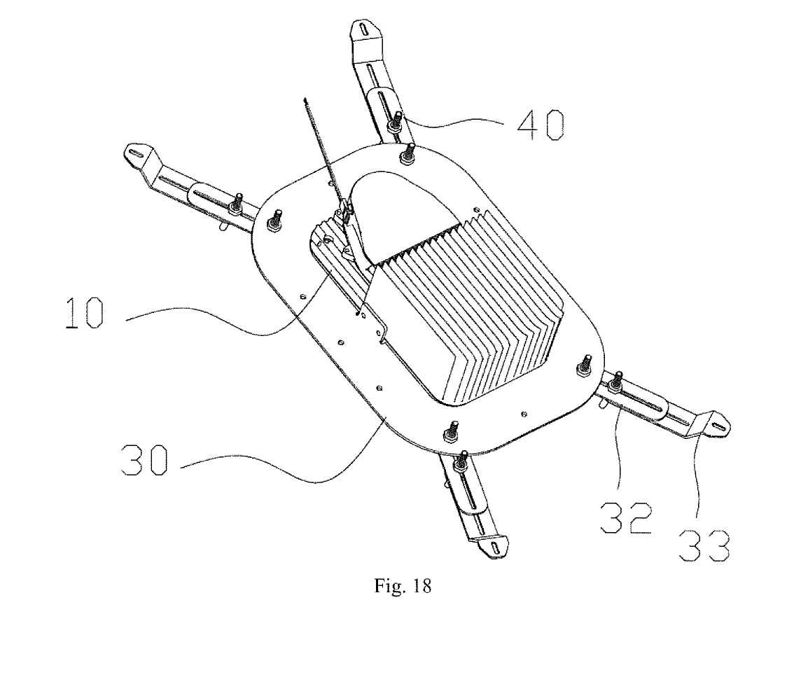

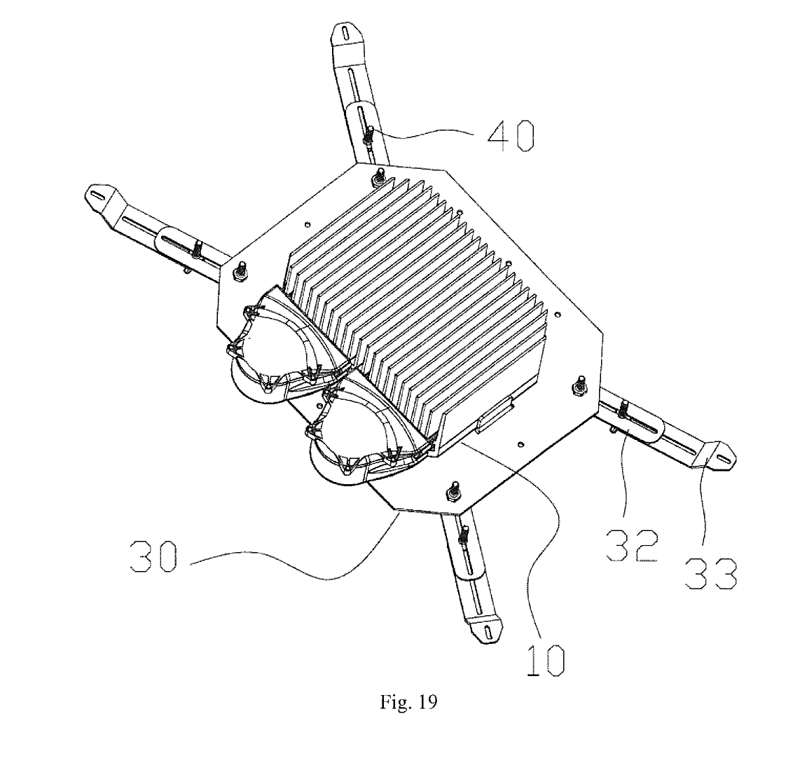

Referring to FIGS. 17 to 19, in a second embodiment, the connecting component includes a mounting plate 30, the base plate 10 is fastened to the mounting plate 30, and a plurality of second brackets 32 are evenly provided along the periphery of the mounting plate 30. The connecting component further includes a plurality of third brackets which can slide along a length of the second brackets, a groove is provided on the second brackets and the third brackets, and fasteners pass through the groove. After the relative position between the second brackets and the third brackets is adjusted, the third brackets 33 can be fastened to the second brackets 32. Preferably, fasteners are wing screws.

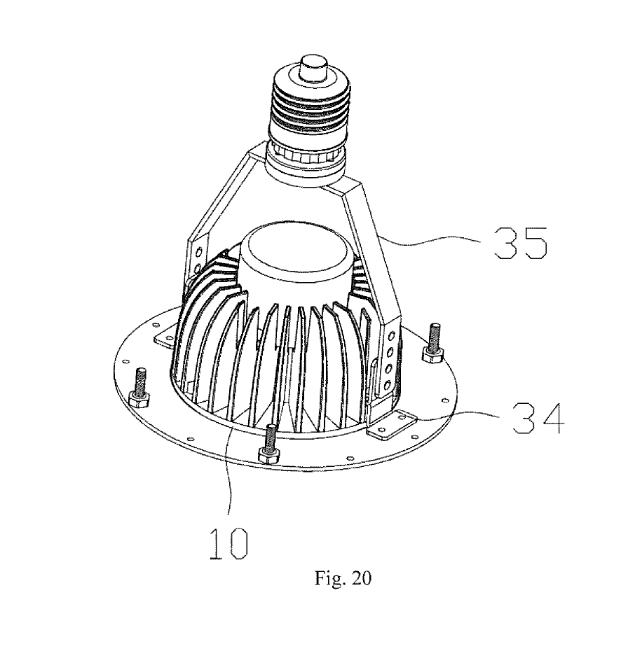

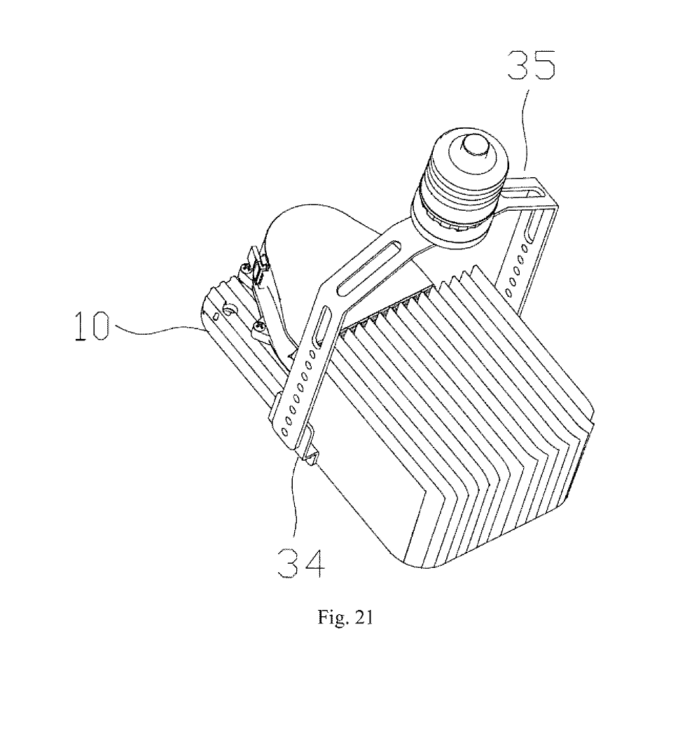

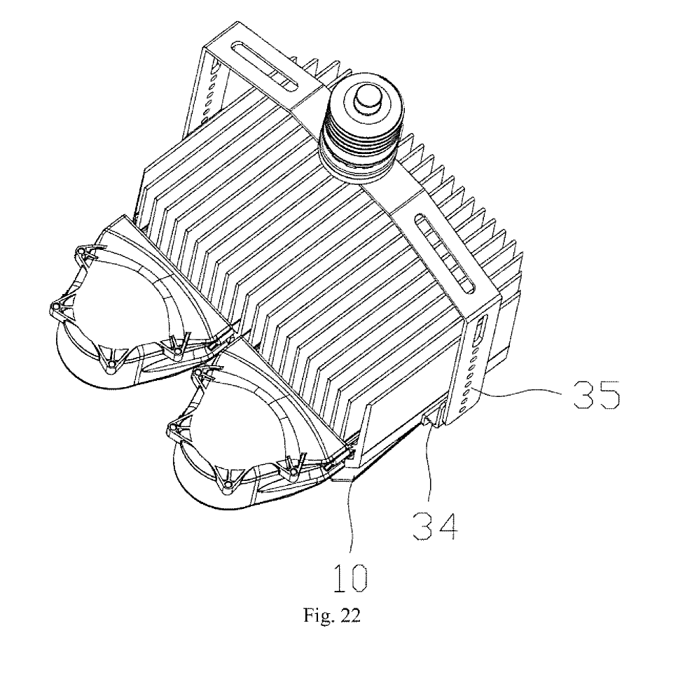

Referring to FIGS. 20 to 22, in a third embodiment, the connecting component comprises a fourth bracket 34 fastened to the base plate 10 and a fifth bracket 35 mounted on the fourth bracket 34. Preferably, a hole is provided on the fourth bracket 34, and a plurality of holes and/or grooves are provided on the fifth bracket 35 along a length of the fifth bracket 35. The relative position between the fourth bracket 34 and the fifth bracket 35 can be adjusted by coordination of different holes and/or grooves on the fifth bracket 35 and the hole on the fourth bracket 34.

A nut and a screw hole are provided on the fifth bracket 35, and can be configured to fix the lamp holder.

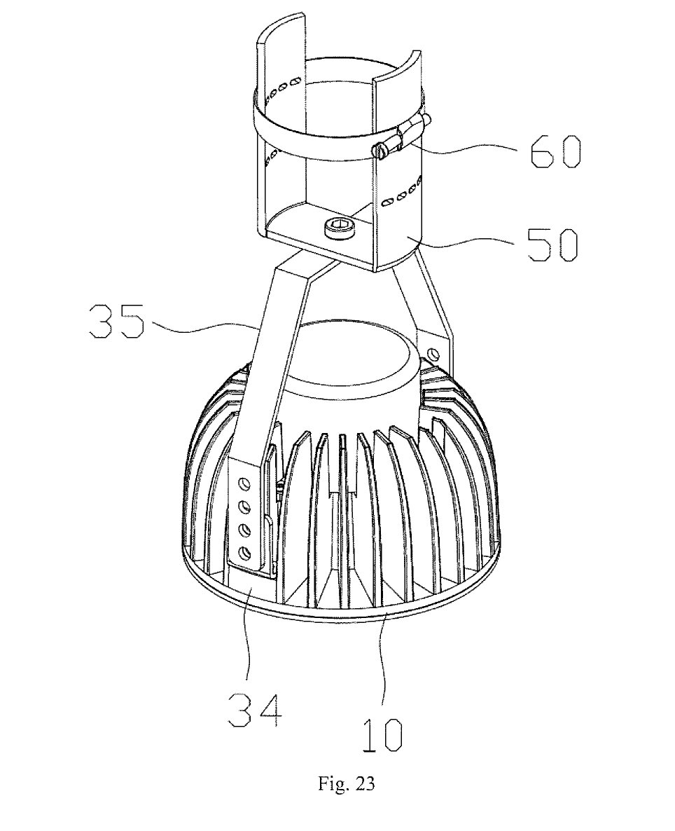

Referring to FIG. 23, in fourth embodiment, the difference from the third embodiment is that a cradle 50 and a clamp 60 are provided on the fifth bracket. The lamp holder can be placed in the cradle 50 and locked by the clamp 60, so that the lamp holder and the heat-dissipating structures are fastened as an integral for facilitating mounting and dismounting operations in future.

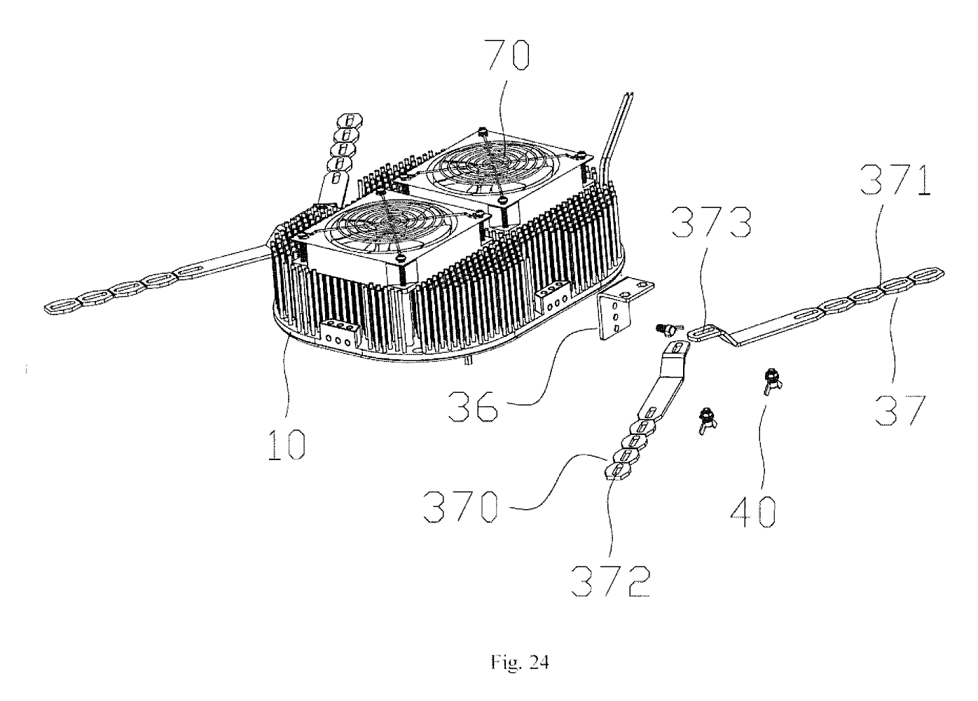

Referring to FIG. 24, in a fifth embodiment, the connecting component includes a connecting base 36 and a sixth bracket 37. The connecting base is of a L shape and a plurality of vertically arranged screw holes are provided on the vertical side wall of the connecting base 36. As connecting members matched with the screw holes, a plurality of horizontally arranged screw holes are provided on the base plate 10. By matching with different screw holes, the connecting base 36 can move in a vertical direction and in a horizontal direction with respect to the base plate 10, so that the position of the connecting base 36 is adjusted. Preferably, the connecting bases 36 are symmetrically provided along the periphery of the base plate 10.

The sixth bracket 37 is bolted on a horizontal side wall of the connecting base 36 by fasteners. Preferably, two sixth brackets 37 are provided on one connecting base 36, and the two sixth brackets 37 are located at a same plane, for fixing the lamp. A plurality of notches 370 and depressions 371 are provided on the sixth bracket 37, the notches 370 are located at both sides of the sixth bracket, the depressions 371 are located at the lowest position of the notches 370 at both sides, so that the sixth brackets 37 can be broken at the position of the depressions 371, for adjusting the length of the sixth brackets 37 to adapt to different mounting cases. A plurality of grooves are also provided on the sixth brackets and are matched with the screw holes and fasteners to fix the lamp. Further, a long circular hole 373 are provided at the connecting position of the sixth brackets 37 and the connecting base 36, and the sixth bracket 37 can adjust the extending length and the angle among the brackets by the long circular hole 373.

Preferably, fasteners 40 both for the connection between the connecting base 37 and the base plate 10 and for the connection between the sixth bracket 37 and the connecting base 37 are wing screws, so that other tools are not required during the mounting process, and the mounting process can be performed by hands.

In the embodiment, the heat-dissipating power source is an electric fan 70.

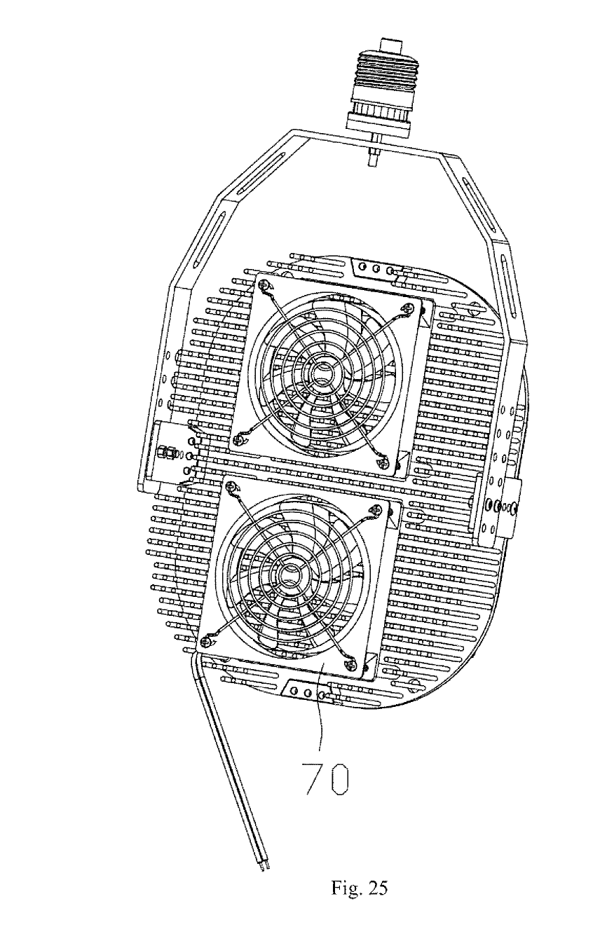

Referring to FIG. 25, in another embodiment of using the electric fan, it should be understood that the electric fan can be applied to any above case of using the air pump as a power source.

In the present application, specific heat dissipation can be performed by attaching the base plate or the mounting plate to the main thermally conductive surface of the heating elements (such as the power supply, the circuit board and the like) and starting the air pump or the electrical fan.

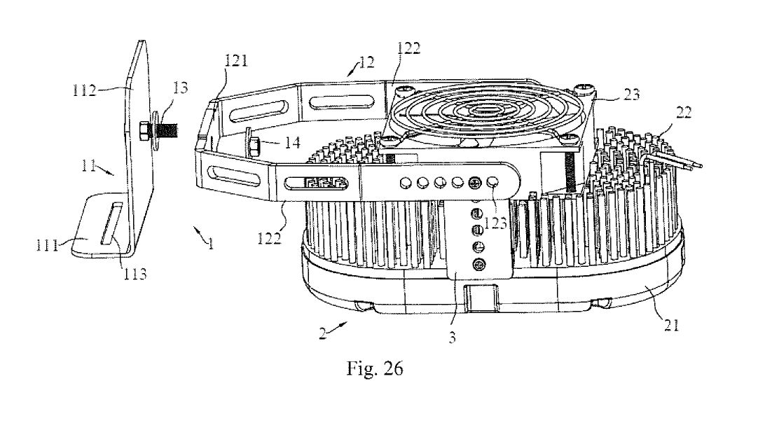

Referring to FIG. 26, In one embodiment, the LED lamp includes a bracket 1 and a lamp 2 provided on the bracket 1; the bracket 1 includes a first bracket 11 and a second bracket 12; the second bracket 12 includes a connecting portion 121 and a connecting arm 122 extending from both ends of the connecting portion 121 to a same side thereof; a screw 13 is provided on the first bracket 11, a fixed hole is provided on the connecting portion 121 of the second bracket 12, the screw 13 extends through the fixed hole of the second bracket 12 and is locked by a nut 14. The screw 133 is used not only as a tightening connection of the first bracket 11 and the second bracket 12, but also as an angle adjusting part for mounting the second bracket 12 on the first bracket 11. When the LED lamp of the present invention is used, the pre-mounted nut 14 on the screw 13 is slacked and unloaded. Then, the screw 13 extends through the fixed hole of the second bracket 12 on which the lamp 2 is mounted and fixed, and the nut 14 is mounted on the screw 13. Further, the screw 13 is regarded as an axis and the emitting light direction of the lamp 2 on the second bracket 12 is adjusted according to the axis, and the second bracket 12 is locked on the first bracket 11 by tightening the nut 14. The LED lamp can be mounted stably without risk of an electric shock while well controlling the angle of radiating light.

The first bracket 11 is an L-shaped bracket having a base plate 111, a vertical plate 112 and an L-shaped cross section; the L-shaped bracket is formed by bending a metal plate; a long hole 113 is provided on the base plate 111 of the L-shaped bracket, and the L-shaped bracket can be mounted in the lamp shade by a tightening screw provided in the long hole 113. A screw hole is provided on the vertical plate 112 of the L-shaped bracket, the screw passes 13 through the screw hole and is pre-mounted on the L-shaped bracket by a preload nut 15.

The second bracket 12 is a U-shaped bracket formed by bending a metal plate, and a plurality of connecting boles 123 for mounting the lamp are provided on an end of the U-shaped bracket. For the lamps 2 of different sizes, different connecting holes can be selected and used for mounting the respective lamps. The lamp 2 includes a heat sink module 21 and a light emitting diode module, a plurality of heat-dissipating structures are provided on the heat sink module 21, an air passage for passing an airflow through is formed among the heat-dissipating passage, connecting sheets 3 are provided at both sides of the heat sink module, and the lamp 2 is fixed to the connecting holes 123 on the connecting arm 122 by the connecting sheets 3.

The heat-dissipating structures include a plurality of cooling fins and/or cooling pins 22 extending from the base plate of the heat sink module 21. A blower 23 is provided on the heat sink module 21. Preferably, the blower includes an air pump and/or an electric fan. An outlet of the blower 23 is aligned with the air passage.

The above embodiments only present a plurality of embodiments of the present invention, the description of which is more specific and detailed. However, it cannot be understood as limitation of the scope of the present invention. It should be indicated that for those skilled in the art, a variety of modifications and changes may be made without departing from the idea of the present invention. Therefore, the scope of the present invention is intended to be defined by the appended claims.

What is claimed is:

1. An LED lamp, comprising:
a housing; and
a heat sink module received on the housing and comprising:
a base plate having a heat-dissipating plane;
a plurality of heat-dissipating structures arranged on another side of the base plate away from the heat-dissipating plane, wherein an air passage is formed among the heat-dissipating structures; and
at least one power device having an air outlet aligned with the air passage.

2. The LED lamp of claim 1, wherein the power device is an air pump and/or an electric fan.

3. The LED lamp of claim 2, wherein the heat-dissipating structures are cooling fins and/or cooling pins which are arranged in parallel with each other.

4. The LED lamp of claim 2, wherein the heat-dissipating structures are cooling fins and/or cooling pins which are arranged in a ring.

5. The LED lamp of claim 2, wherein the heat-dissipating structures are cooling fins provided with a plurality of ripple structures thereon.

6. The LED lamp of claim 1, wherein a groove is provided on the heat-dissipating structures.

7. The LED lamp of claim 1, wherein the base plate is provided with an extending portion configured to mount the power device.

8. The LED lamp of claim 1, wherein the power device is surrounded by the heat-dissipating structures.

9. The LED lamp of claim 1, wherein the heat sink module comprises two horizontally arranged power devices, the two power devices are located at a same side of the heat-dissipating structures in parallel, or at both sides of the heat-dissipating structures symmetrically.

10. The LED lamp of claim 1, wherein the power device is arranged in a vertical or horizontal direction.

11. The LED lamp of claim 1, further comprising a connecting component configured to fasten the housing and the heat sink module.

12. The LED lamp of claim 11, wherein the connecting component comprises:
a mounting plate fastened to the base plate; and
a plurality of first brackets provided along a periphery of the mounting plate, wherein each bracket defines a plurality of depressions which are evenly distributed and perpendicular to a length direction thereof.

13. The LED lamp of claim 11, wherein the connecting component comprises:
a mounting plate fastened to the base plate;
a plurality of second brackets provided along a periphery of the mounting plate;
a plurality of third brackets being able to slide along a length of the second brackets; and
a fastener;
wherein each second and third brackets define a groove and the fastener extends through the groove.

14. The LED lamp of claim 11, wherein the connecting component comprises:
a fourth bracket fastened to the base plate;
a fifth bracket mounted on the fourth bracket; and
a cradle and a clamp provided on the fifth bracket;
wherein a relative position between the fourth bracket and the fifth bracket is adjustable; the fourth bracket defines a hole; the fifth bracket defines a plurality of holes and/or grooves along a length of the fifth bracket.

15. The LED lamp of claim 11, wherein the connecting component comprises:
a mounting base having a L shape and adjustably mounted on the base plate by its vertical side wall; and
a sixth bracket;
wherein the sixth bracket defines a plurality of notches provided at both sides of the sixth bracket symmetrically, a plurality of depressions perpendicular to a length of the sixth bracket and connected to the lowest position of the notches at both sides, a groove provided along the length of the sixth bracket, and a long circular hole; a vertical side wall of the mounting base can be adjusted; when the sixth bracket is bolted on a horizontal side wall of the mounting base by the long circular hole, an angle and an extending portion length of the sixth bracket is adjustable.

16. An LED lamp, comprising:
a bracket comprising:
a first bracket provided with a screw; and
a second bracket comprising a connecting portion and two connecting aims extending from both ends of the connecting portion along a same side thereof;
wherein the second bracket defines a fixing hole on the connecting portion, the screw extends through the fixing hole and is locked by a nut, thereby fastening the second bracket to the first bracket; and
a lamp mounted on the connecting arms.

17. The LED lamp of claim 16, wherein the first bracket is an L-shaped bracket having a base plate and a vertical plate extending from the base plate; the base plate defines an elongated hole, and the screw is located on the vertical plate.

18. The LED lamp of claim 17, wherein the L-shaped bracket is formed by bending a metal plate.

19. The LED lamp of claim 17, wherein a screw hole is provided on the vertical plate of the L-shaped bracket, the screw extends through the screw hole and is pre-mounted on the L-shaped bracket by a preload nut.

20. The LED lamp of claim 16, wherein the second bracket is a U-shaped bracket formed by bending a metal plate, and a plurality of connecting holes for mounting the lamp are provided on an end of the U-shaped bracket.

21. The LED lamp of claim 16, wherein the lamp comprises a heat sink module and a light emitting diode module, wherein a plurality of heat-dissipating structures are provided on the heat sink module, an air passage for passing an airflow through is formed among the heat-dissipating structures, connecting sheets are provided at both sides of the heat sink module, and the light emitting diode module is mounted on the connecting arm of the second bracket by the connecting sheets.

22. The LED lamp of claim 21, wherein the heat-dissipating structures comprise a plurality of cooling fins and/or cooling pins extending from a base plate of the heat sink module.
